(19) United States
(12) Patent Application Publication
(10) Pub. No.: US 2012/0209859 A1
(43) Pub. Date: Aug. 16, 2012

(54) METHODS AND SYSTEMS TO PROFILE INDIVIDUALS AND ORGANIZATIONS, AND TO EVALUATE CULTURE FIT

(76) Inventor: Forrest Blount, Cambridge, MA (US)

(21) Appl. No.: 13/372,280

(22) Filed: Feb. 13, 2012

Related U.S. Application Data
(60) Provisional application No. 61/441,678, filed on Feb. 11, 2011.

(51) Int. Cl. G06F 17/30

(52) U.S. Cl. 707/748; 707/E17.084

(57) ABSTRACT

Methods and systems to construct and analyze a cultural profile of an entity, and to organize and analyze a social network profile of an entity.

### BACKGROUND

A graph or network may be used to represent relationships amongst natural and man-made systems.

A graph or network may include nodes to represent things, and edges to represent relationships between the things.

Relationships amongst people may be represented with a social graph, which may also be referred to as a collaboration graph or sociological graph. A social graph may include nodes to represent members, and edges to represent relationships between members.

Conventionally, social graphs are used to measure degrees of closeness amongst the members.

### BRIEF DESCRIPTION OF THE DRAWINGS/FIGURES

FIG. 1 is a flowchart of a method 100 of generating a corporate network.

FIG. 2 is a flowchart of a method 200 of generating a culture profile.

FIG. 3 is a block diagram of a computer system configured to generate a corporate network and/or a culture profile.

In the drawings, the leftmost digit(s) of a reference number identifies the drawing in which the reference number first appears.

### DETAILED DESCRIPTION

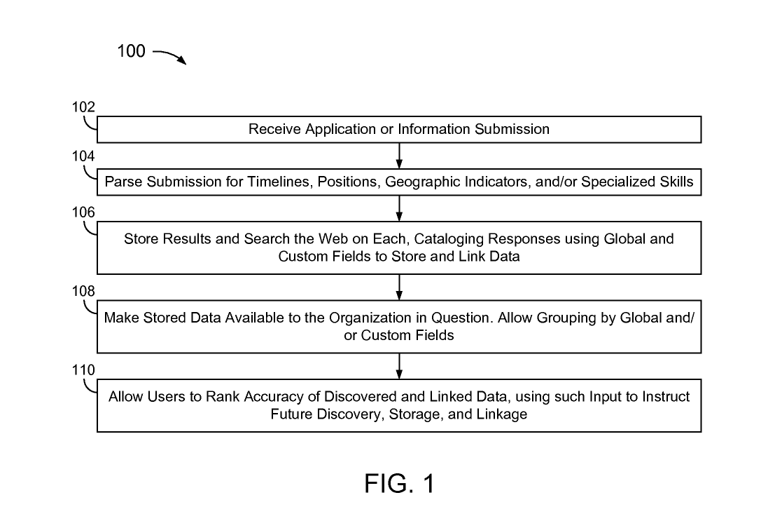

FIG. 1 is a flowchart of a method 100 of generating a corporate network to facilitate relatively simple transfer and inheritance of information, which may already in existence within an organization and/or in one or more internal and/or external social networks (104), grouping of information based on terms of unique interest to the corporation (108), such as relationships to competitors, cultural/geographic familiarities, former lines of work, hobbies, skill sets are examples, and to search and sort member profiles based on one or more of a variety of attributes, which may be defined globally and/or by the specific organization (110).

At 102 an applicant applies for a position submitting their resume or online profile to the employer organization. Alternatively, the employer organization may feed resumes or profiles of current employees or may direct the application to other available information sources.

At 104, the submitted data is parsed for default data types such as timelines, positions, geographic indicators, skills, and any links to additional data sources. Customized data types specified by the employer organization are also checked.

At 106, results of the parsing may be stored and/or used to generate queries to general information stored across the internet. Responses may be vetted for pertinence to the applicant and/or the employer organization. Responses that pass may be stored and/or assessed to generate subsequent queries.

At 108, the employer organization may access the results. The access may include searching, sorting and/or filtering, such as by default and/or customized data types.

At 110, as users in the employer organization use the application, feedback on the accuracy of data found 106 may be solicited and the feedback may be used to further train the application.

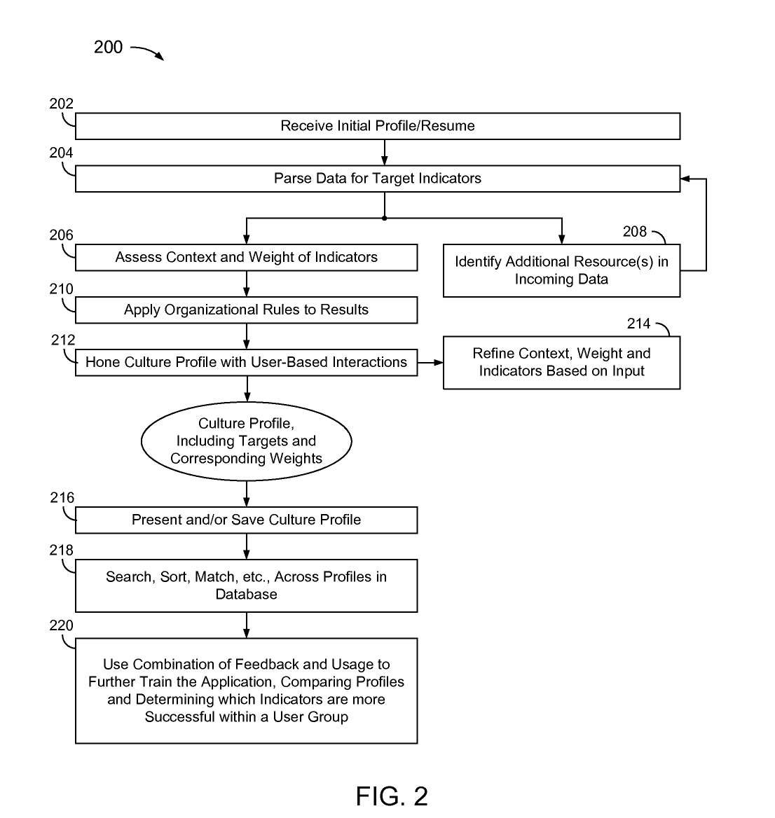

FIG. 2 is a flowchart of a method 200 of generating a culture profile for applicants, which may be performed with relatively minimal manual interaction with a subject, and may use direct questioning only as a control or to refine results when the subject is identified as being outside a standard range of results (212). By focusing on an automated evaluation, results may be generated relatively quickly over relatively large sets of data, which may permit the method to be applied relatively early in a hiring process and/or to a relatively large number of job applicants.

At 202, a user submits a resume or online profile to the application. This may include a user submitting their resume, an HR manager submitting a list of employees, and/or a background process when a user submits their data to an online job board.

At 204, indicators may be retrieved from a database and the submitted data may be parsed or analyzed with respect to the indicators. An indicator may include a phrase, such as “cognitive dissonance”, and/or a tone or expression found in a video clip. Other indicator types may be used.

At 206, as indicators are found, their respective context and weight (context, weight and indicators are pre-supplied to the application independent of this workflow) are assessed. An indicator found in a user's blog may be scored differently than the same indicator found in a status update.

At 208, submitted data may also be parsed for general data types of interest, including blogs, twitter account information, former employers, former positions, dates of employ, etc. Results may be used to generate additional queries whose results are fed back to 204, where they can be scanned for indicators.

At 210, an organization using the application may apply custom rules and filtering behavior based on their profiling needs. Any such specifications are assessed at 210 and used to modify the results from 206. An organization could specify that “cognitive dissonance” is an important indicator and double its weight, or the application could learn based on usage that it was a more successful indicator than average and increase its weight, such as at 220.

At 212, as needed, additional information may be required or requested of the user submitting data. 212 may include, the application may allow for the questions, answers and other input from the user that will either confirm the accuracy of the profile that was generated or improve it. For example, if the application finds few indicators, it could prompt the user with questions until sufficient data was obtained that the culture profile weight passed a specified threshold.

At 214, user input entered at 212 may be used to modify the formula applied to the found indicators. This may include asking questions to prompt the user to provide additional resources for parsing at 204, and/or present question sets that, by themselves, affect the weight of one or more targets.

At 216, the culture profile, including targets and weights, may presented to the user and/or saved for future use.

At 218, users with appropriate privilege may access the data store, such as to perform searches, ordering, comparison and/or filtering across profiles.

At 220, as users interact with the data and the users whose data created the profiles (either theirs or someone else's) their feedback is solicited and their usage is recorded to further train the application. For example, determining which indicators are most accurate or which profiles most sought after.

Methods and systems disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, and/or a combination of integrated circuit packages. Software may include a computer readable medium encoded with a computer program including instructions to cause a processor to perform one or more functions in response thereto. The computer readable medium may include a transitory and/or non-transitory medium. The processor may include a general purpose instruction processor, a controller, a microcontroller, and/or other instruction-based processor.

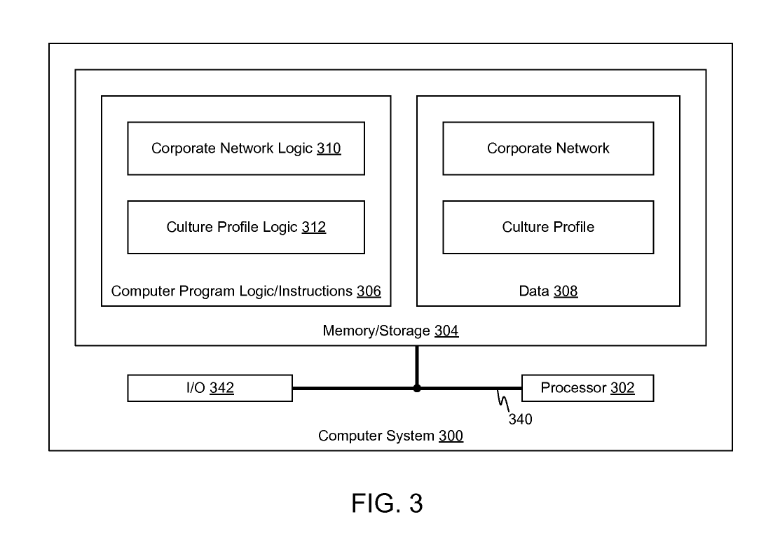

FIG. 3 is a block diagram of a computer system 300, configured to . . . .

Computer system 300 includes one or more computer instruction processing units and/or processor cores, illustrated here as a processor 302, to execute computer readable instructions, also referred to herein as computer program logic.

Computer system 300 may include memory, cache, registers, and/or storage, illustrated here as memory 304, which may include a non-transitory computer readable medium encoded with a computer program, illustrated here as a computer program 306.

Memory 304 may include data 308 to be used by processor 302 in executing computer program 306, and/or generated by processor 302 during execution of computer program 306.

Logic 306 may include corporate network instructions 310 to cause processor 302 to generate a corporate network, such as described above with reference to FIG. 1.

Alternatively, or additionally, logic 306 may include culture profile instructions 312 to cause processor 302 to generate a culture profile, such as described above with reference to FIG. 2.

Computer system 300 may include a communications infrastructure 340 to communicate amongst devices of computer system 300.

Computer system 300 may include an input/output controller 342 to interface with one or more other systems.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the examples disclosed herein.

What is claimed is:

1. A machine-implemented method, comprising:
accessing information associated with a first entity;
identifying data points within the information;
assigning attributes and attribute weights to the data points as a function of one or more features of the data points; and
selecting and ordering a reduced set of the weighted attributes as a culture profile of the first entity.

2. The method of claim 1, wherein the accessing includes accessing one or more of:
a web site;
a blog;
a social network web site;
a database;
a local storage device; and
a network-based storage device.

3. The method of claim 1, wherein the identifying includes identifying data points within one or more of:
computer-readable text;
a computer-renderable image;
computer-renderable video;
digitized speech;
information appended to one or more of the computer-renderable image, the computer-renderable video, and the digitized speech;
information appended to a computer-based data object;
a computer-readable communication;
an attachment to a computer-readable communication; and
electronic communication records, including one or more of contact identifications, communication times, communication durations, and communication content.

4. The method of claim 1, wherein one or more of the data points correspond to one or more of:
a textual feature;
an image feature;
a video feature;
a speech feature;
an audio feature;
a date;
a date range;
a timeline; and
a computer-readable link.

5. The method of claim 1, wherein the assigning of the attributes and the attribute weights includes assigning one or more of an attribute and an attribute weight as a function of one more of:
a number of instances of a data point within the information;
contextual information associated with the data point;
an information source from which the data point is identified;
a hierarchical context of the data point within the information; and
the relative position of a keyword within the information.

6. The method of claim 1, wherein the data points include a computer-readable link, and wherein the assigning of attributes and attribute weights includes:
assigning one or more of an attribute and an attribute weight to the computer-readable-link based on a destination address of the computer-readable link; and
accessing and assessing information from a destination address of the link.

7. The method of claim 1, wherein the data points include social network graph information of the first entity and the assigning of attributes and attribute weights includes:
assigning one or more of an attribute and an attribute weight as a function of one or more contacts within the social network.

8. The method of claim 1, wherein the accessing includes one or more of:
assessing information generated by the first entity and assessing additional information associated with the first entity from an information source; and
comparing the additional information with the information generated by the first entity to validate the information generated by the first entity.

9. The method of claim 1, wherein the identifying of data points includes one or more of:
selecting a subset of the data points for which to assign the attributes and attribute weights;
prioritizing at least a subset of the data points for the assigning of the attributes and attribute weights;
filtering at least a subset of the data points; and
processing at least a subset of the data points according to one or more rules, including processing based on rules and one or more configurable parameters.

10. The method of claim 1, further including:
configuring one or more parameters to generate the culture profile relative to a metric, wherein the metric includes one or more of a norm and a difference from a norm, and wherein the norm is relative to one or more of a second entity, a position or role within an entity, and an individual.

11. The method of claim 1, wherein the selecting and ordering of attributes includes one or more of:
selecting or ordering at least a subset of the weighted attributes based on user input; and
processing based on user-specified attributes.

12. The method of claim 1, further including representing the culture profile as one or more of:
a computer-searchable data structure;
a graph;
a model; and
a computer-renderable picture.

13. The method of claim 1, further including:
repeating the accessing, the identifying, the assigning, and the selecting and ordering with respect to a second entity to generate a culture profile of the second entity; and
comparing one or more features of the first and second entity culture profiles to determine one or more of a similarity and a dissimilarity between the first and second entities.

14. The method of claim 1, further including:
receiving additional information associated with the first entity subsequent to generation of the first entity culture profile; and
revising the first entity culture profile in response to the additional information, wherein the revising includes,
identifying additional data points within the additional information,
assigning attributes and attribute weights to the additional data points,
assigning attributes and attribute weights to the additional data points as a function of one or more features of the additional data points,
selecting and ordering a reduced set of the additional weighted attributes,
adding the reduced set of the additional weighted attributes to the first entity culture profile,
combining the additional data points with the original data points,
repeating the assigning of attributes and attribute weights with respect to the combined data points, and
repeating the selecting and ordering to identify a new reduced set of the weighted attributes to generate a revised culture profile of the first entity.

15. A system, comprising a computer system configured to:
access information associated with a first entity;
identify data points within the information;
assign attributes and attribute weights to the data points as a function of one or more features of the data points; and
select and order a reduced set of the weighted attributes as a culture profile of the first entity.

16. A machine-implemented method, comprising:
receiving social network graph information associated with members of a first entity;
indexing the social network graph information of the members; and
generating a social network graph of the first entity from the indexed information.

17. The method of claim 16, further including:
extrapolating social network connections from the social network graph of the first entity to a social network graph of a second entity, wherein the second entity includes one or more of,
an individual,
an applicant for membership within the first entity,
an applicant for employment with the first entity,
a multi-member entity,
a customer of the first entity, and
a competitor of the first entity.

18. A system, comprising a computer system configured to:
receive social network graph information associated with members of a first entity;
index the social network graph information of the members; and
generate a social network graph of the first entity from the indexed information.

19. A machine-implemented method, comprising:
tagging data points within training information in response to user input, including identifying the data points in response to user input and identifying contextual information associated with the data points, wherein,
the data points include one or more of keywords, phrases, links, images, audio, video, tone, facial expressions, social graphs, timelines, and title, and
the contextual information includes one or more of quantity, relative location within the information, order, hierarchy, and source;
associating attributes to the training information in response to user input; and
learning a relationship between the tagged data points and the attributes to correlate the training information to the attributes, wherein the learning includes assigning at least one of the attributes and a corresponding attribute weight to each of the data points as a function of the corresponding data point and contextual information.

20. The method of claim 18, further including:
receiving information associated with a first entity;
parsing one or more of the data points from the first entity information, wherein the parsing includes identifying the one or more data points and identifying contextual information associated with the one or more data points;
assigning at least a subset of the attributes, and a corresponding attribute weight, to at least a subset of the data points of the first entity information as a function of the corresponding data point and contextual information;
selecting and ordering a reduced set of the weighted attributes of the first entity information to define a culture profile of the first entity; and
selecting and ordering the reduced set of the weighted attributes as a function of a relevancy measure.

21. A system, comprising a computer configured to:
tag data points within training information in response to user input, including to identify the data points in response to user input and to identify contextual information associated with the data points, wherein,
the data points include one or more of keywords, phrases, links, images, audio, video, tone, facial expressions, social graphs, timelines, and title, and
the contextual information includes one or more of quantity, relative location within the information, order, hierarchy, and source;
associate attributes to the training information in response to user input; and
learn a relationship between the tagged data points and the attributes to correlate the training information to the attributes, including to assign at least one of the attributes and a corresponding attribute weight to each of the data points as a function of the corresponding data point and contextual information.
